(19) United States
(12) Patent Application Publication
(10) Pub. No.: US 2026/0112363 A1
(43) Pub. Date: Apr. 23, 2026

(54) Audio Device with Ambient Sound Source Selection and Natural Language Control

(71) Applicant: Bose Corporation, Framingham, MA (US)

(72) Inventors: Colin Douglas Fletcher, Needham, MA (US); Andrew Todd Sabin, Chicago, IL (US)

(21) Appl. No.: 18/924,359

(22) Filed: Oct. 23, 2024

(51) Int. Cl. G10L 15/22; G06F 3/16; G10K 11/178

(52) U.S. Cl. CPC G10L 15/22; G06F 3/165; G10K 11/17823

(57) ABSTRACT

Various implementations include approaches for device control and/or sound source selection in audio devices. In some implementations, an audio device includes: an electro-acoustic transducer for providing an audio output; a set of microphones for detecting ambient sounds; and a processor coupled with the electro-acoustic transducer and the set of microphones, the processor configured to: evaluate microphone signals from the set of microphones to identify classes of sound sources in the ambient sounds; and adjust output of at least one class of the ambient sounds relative to another class of ambient sounds based on a user input.

### TECHNICAL FIELD

This disclosure generally relates to audio devices and control functions. More particularly, the disclosure relates to ambient sound source selection and/or conversational-style control for audio devices.

### BACKGROUND

Controlling noise in conventional audio devices can present challenges for many users. For example, many control functions related to noise control (or noise reduction) impact overall sound, or certain frequencies, and result in pass-through of unwanted noise and/or blocking of desired acoustic signals.

Further, conventional interface controls for audio devices can present challenges. For example, controlling headphones, hearing aids, and/or speakers using on-product buttons can be limiting, while controlling such devices with mobile applications can be overwhelming or unnecessarily complicated. Further, control via voice assistant can be inefficient and frustrating for certain users.

### SUMMARY

All examples and features mentioned below can be combined in any technically possible way.

Various implementations include approaches for device control and/or sound source selection (including, e.g., detection) in audio devices. In some implementations, an audio device includes: an electro-acoustic transducer for providing an audio output; a set of microphones for detecting ambient sounds; and a processor coupled with the electro-acoustic transducer and the set of microphones, the processor configured to: evaluate microphone signals from the set of microphones to identify classes of sound sources in the ambient sounds; and adjust output of at least one class of the ambient sounds relative to another class of ambient sounds based on a user input.

Additional implementations include an audio device having: an electro-acoustic transducer for providing an audio output; a set of microphones for detecting ambient sounds; and a processor coupled with the electro-acoustic transducer and the set of microphones, the processor configured to: receive a user natural language command to adjust a control function (or multiple control functions) at the audio device; convert the user natural language command into a natural language input; provide the natural language input to a machine learning (ML) model for identifying the control function based on the natural language input; receive a formatted response indicating the control function from the ML model; and execute the control function at the audio device based on the formatted response.

In additional particular aspects, a method of controlling an audio device includes: evaluating microphone signals from a set of microphones to identify classes of sound sources in ambient sounds; and adjusting output of at least one class of the ambient sounds relative to another class of ambient sounds based on a user input.

In further particular aspects, a method of controlling an audio device includes: receiving a user natural language command to adjust a control function at the audio device; converting the user natural language command into a natural language input; providing the natural language input to a machine learning (ML) model (e.g., a large language model) for identifying the control function based on the natural language input; receiving a formatted response indicating the control function from the ML model; and executing the control function at the audio device based on the formatted response.

Additional implementations include a method of interfacing with a large language model (LLM) for sound source classification, the method including: training the LLM by: capturing microphone signals including ambient sounds from a set of microphones at an audio device; detecting classes of sound sources in the ambient sounds; and providing the microphone signals and sound source classifications to the LLM to aid in future classification of ambient sounds.

Implementations may include one of the following features, or any combination thereof.

In some cases, the processor is configured to identify at least one of the following classes of sound sources: i) nearby voice, ii) alerts and sirens, iii) nearby transit, iv) out loud music, v) background sounds, and vi) nature (or, natural) and animals. In some examples, background sounds can include machine sounds, steady environmental sounds, etc.

In some cases, the processor is configured to operate in a plurality of modes including two or more of: a) quiet mode, b) aware mode, c) safety mode, d) atmosphere mode, e) voice boost mode, or f) custom mode.

In some cases, the processor is configured to automatically select one of the plurality of modes based on at least one of a contextual indicator or a usage indictor. Automatic selection can be performed without an intervening user command.

In some cases, the processor is configured to provide at least three interface options for sound source selection.

In some cases, the interface options include a full manual control, whereby the user adjusts a plurality of classes of ambient sounds on a per-class basis. In some examples, the per-class selection can be performed via a user interface selection feature, e.g., at least one slider, toggle, button, dial, knob, etc.

In some cases, the interface options include a modes-based control, whereby predefined mixes of class-based settings are provided to the user for selection.

In some cases, the interface options include a natural language (NL) based control mode, whereby the at least one class of sound sources is selected by a user natural language command.

In some cases, in the NL based control mode, the processor is configured to: convert the user natural language command into a natural language input; and provide the natural language input to a machine learning (ML) model for identifying the at least one class of sound sources based on the natural language input.

In some cases, the processor is further configured to provide at least one of the following to the ML model: audio device context data about usage of the audio device, or a set of controllable attributes for the audio device.

In some cases, the set of controllable attributes are defined in terms of an application programming interface (API). In some examples, the API includes JSON.

In some cases, the ML model includes a large language model (LLM).

In some cases, the processor is configured to differentiate between user input (e.g., selection) of ambient acoustic signals that include music from music playback at the audio device.

In some cases, the user input is provided via a voice command.

In some cases, the user input is provided via a text command.

In some cases, the user input is provided via an input from one or more sensors at the audio device.

In some cases, the user input is provided via a user profile command.

In some cases, the user input is a default user input at startup of the audio device.

In some cases, the user input is an inferred user input derived from one or more audio device contextual cues.

In some cases, the audio device is an occluding headset.

In some cases, the audio device is a non-occluding headset.

In some cases, the ML model is run at a device separate from the audio device.

In some cases, a version of the ML model is run locally at the audio device.

In some cases, the version of the ML model run locally at the audio device is a lightweight version of the ML model.

In certain cases, a control action can include at least one of a change in the attribute or maintaining the attribute.

In particular implementations, determining the control action includes selecting the at least one attribute of the audio device based on inferred intent from the user input.

In certain cases, the inferred intent is determined based on a nested selection approach. In some aspects, the nested selection approach includes, applying a local portion of the ML model run on the at least one audio capture device or the audio device to determine the control action, and if the at least one attribute of the audio device is not selected by applying the local portion of the ML model, applying an off-device portion of the ML model to determine the control action. In particular implementations, the off-device portion of the ML model is run on a smart device other than the audio capture device and/or a cloud-based or network-based system.

In particular aspects, control functions of the audio device enable control of at least one of, ambient noise source selection and/or filtering, transport control, volume, active noise reduction (ANR), audio device grouping, equalization, spatial audio controls (e.g., motion versus still), transparency mode, or channel playback (e.g., stereo, left/right, coordinating channels with another speaker, and/or party mode). In further aspects, control functions of a service utilized by the audio device enable control of at least one of, a song or a track, an artist, a playlist, or a content channel.

In some cases, a method further includes providing a set of controllable attributes for the audio device to the ML model. In certain cases, the controllable attributes are defined in terms of an application programming interface (API). In particular cases, the set of controllable attributes is provided to the ML model prior to waiting for the user natural language command, e.g., listening for a user voice command, receiving a text command, receiving a sensor input command, etc. In certain aspects, the set of controllable attributes for the audio device is provided to the ML model with the user input.

In some implementations, the method further includes providing a set of audio device context data to the ML model for use in determining the control action for the at least one attribute. In some cases, the audio device context data can include: usage data, device state data (e.g., on, outputting audio, sleep mode, listening mode, paired with X, etc.), data about the known or likely user (e.g., based on proximity of user device such as smart phone), user profile data, data about location of the audio device (e.g., in the kitchen), data about the type of audio device (e.g., soundbar v. portable audio device v. wearable audio device), time of day, prior and/or last-paired device data, etc. In certain examples, context data can be provided with the user input, or ahead of time.

In particular aspects, routing the user input through the ML model includes defining a format of a response from the ML model including the control action. In one example, the format includes an object-based format such as JSON.

In some cases, the ML model is cloud-based.

In certain aspects, the ML model includes at least one of, a large language model (LLM) or a large action model (LAM) or a large multimodal model (LMM).

In some cases, a method further includes providing natural language (NL) prompts to the LLM associated with the sound source classifications.

In some cases, a method further includes providing contextual usage cues for the audio device with the sound source classifications and microphone signals.

In some cases, a method further includes running the LLM by: sending natural language (NL) prompts to the LLM associated with detected user inputs; and receiving audio device settings values from the LLM based on the user inputs.

In some cases, the user inputs include contextual cues inferring user intent based on operation of the audio device.

In some cases, the user inputs include at least one user selection.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including at least one audio device, according to various disclosed implementations.

FIG. 2 is a flow diagram illustrating processes in a method according to various implementations.

FIG. 3 is a depiction of an example interface for ambient noise source classification selection according to various implementations.

FIG. 4 is a schematic data flow diagram illustrating processes in executing control actions based on user inputs according to various implementations.

FIG. 5 is a flow diagram illustrating processes in a method of controlling an audio device according to various implementations.

FIG. 6 shows an example prompt-response pairing for a machine learning (ML) model according to various implementations.

FIGS. 7-9 show examples of prompt-response pairings for a ML model according to various additional implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that ambient sound sources can be selectively enhanced and/or reduced to enhance the user experience. For example, one or more classes of ambient sound source can be adjusted in audio output based on a user input, e.g., a user selection and/or input(s) from one or more contextual usage cues detected at a device.

This disclosure is also based, at least in part, on the realization that natural language-based audio device controls and/or additional device control inputs can benefit from use of a machine learning (ML) model. In particular cases, the ML model need not have been pre-trained with user input to determine a control action for at least one audio device attribute. In some cases, the ML model is stored remotely from the audio device.

Commonly labeled components in the FIGURES are considered to be substantially equivalent components for the purposes of illustration, and redundant discussion of those components is omitted for clarity. Various features of portable speakers, headsets, and natural language controls are described herein, however, additional features of such speakers may be relevant to the disclosed implementations. Such additional features can be described in U.S. Patent Application Ser. No. 18/661,893 (“Machine Learning Based Voice Control for Audio Device,” filed May 13, 2024), Ser. No. 18/238,668 (“Content-Based Audio Spatialization,” filed Aug. 28, 2023), Ser. No. 18/835,997 (“Dynamic Portable Speaker Grouping,” filed Nov. 1, 2023), and Ser. No. 18/387,144 (“Audio System Control Device,” filed Nov. 6, 2023), and U.S. Pat. No. 11,521,643 (“Wearable Audio Device with User Own-Voice Recording,” issued Dec. 6, 2022), U.S. Pat. No. 10,657,965 (“Conversational Audio Assistant,” issued May 19, 2020), U.S. Pat. No. 10,721,560 (“Intelligent Beam Steering in Microphone Array,” issued Jul. 21, 2020), U.S. Pat. No. 10,580,430 (“Noise Reduction Using Machine Learning,” issued Mar. 3, 2020), and U.S. Pat. No. 12,022,268 (“Artificial Intelligence (AI) Acoustic Feedback Suppression,” issued Jun. 25, 2024), each of which is incorporated by reference in its entirety.

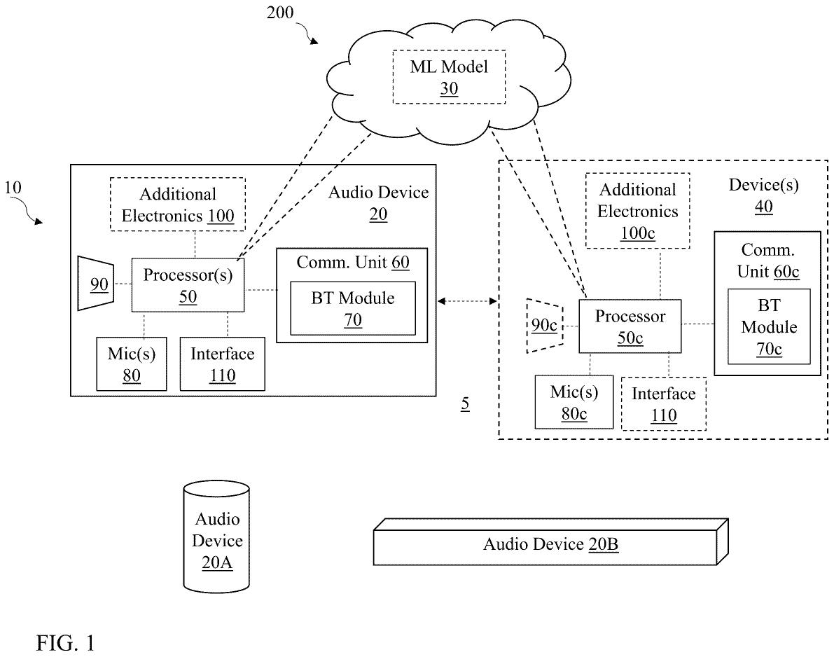

FIG. 1 shows an example of an environment (or, space) 5 including a system 10 with a set of devices according to various implementations. In various implementations, the system 10 is shown including one or more audio devices 20 configured to provide an audio output, e.g., to space 5. In some examples, not depicted, a plurality of audio devices can be located in space 5. As described herein, in various implementations the audio device 20 can include a speaker or a wearable audio device such as a set of headphones or body-worn speakers. In certain implementations, the audio device 20 includes a wearable audio device such as banded, wired, or wireless headphones, which can include occluding or non-occluding wearable headphones. In certain examples, the audio device 20 includes a fixed or portable speaker. In certain cases, a portable speaker includes a portable loudspeaker such as a portable smart speaker, a portable home speaker, or a portable public address (PA) system. In certain example cases, one or more audio devices 20 is configured to facilitate natural language control using a machine learning (ML) model 30. As described herein, the ML model 30 can be run (operated and/or stored) locally at the audio device 20 and/or at another device 40 in the space 5. In additional cases, the ML model 30 is run (e.g., operated and/or stored) in a remote or distributed computing system such as a network or cloud-based platform. In certain aspects, the system 10 is located in or around space 5, e.g., an enclosed or partially enclosed room in a home, office, theater, sporting or entertainment venue, religious venue, etc. In some cases, the space 5 has one or more walls and a ceiling. In other cases, the space 5 includes an open-air venue that lacks walls and/or a ceiling.

In one example implementation, another device 40 such as a smart device can be located in the space 5 and can be configured to communicate with the audio device 20 according to various implementations. In certain examples, device 40 can include a communications device, an audio gateway device, a computing device, etc. In various implementations, device 40 is a personal electronic device such as a smart phone, smart watch, or tablet computing device.

In certain cases, the audio device 20 is capable of being connected with device 40 and/or another device such as an additional audio device 20, a charging hub, an amplifier, a home entertainment system, etc. Two or more devices (e.g., audio device 20 and device 40) can communicate with one another using any communications protocol or approach described herein.

One or more of the audio devices 20 can include a portable speaker, such as a portable home speaker. It is understood that a “portable speaker” or a “portable home speaker” as described herein can refer to any of a number of speakers that are configured for wired and/or wireless operation, and are configured to change location. In certain cases, such speakers are labeled as “portable,” but this is not necessary in all implementations. Further, portable speakers and portable home speakers can be configured to charge in a dock, wirelessly charge, and/or remain connected to an external power source such as an outlet or additional device while outputting audio. Non-limiting examples of portable speakers provided by Bose Corporation (Framingham, MA, USA) can include the Bose Portable Smart Speaker, the Bose SoundLink Flex, the Bose SoundLink Micro, the Bose SoundLink Mini II, and/or the Bose SoundLink Revolve II (product names truncated for brevity). One or more audio devices described herein may be described as “fixed,” meaning that the audio device is designed to output audio in a static location or is configured to be mounted or otherwise fixed in a location. Certain examples of fixed speakers include wall or ceiling-mounted speakers, recessed speakers, speakers that form part of a surround sound unit in a home or other room entertainment system, and/or fixed speakers in a conference room, office, indoor/outdoor space, etc.

In a particular example, the audio device 20 includes an occluding or non-occluding headset such as an on-ear, over-ear, in-ear (e.g., earbud), or near-ear headset that is configured to provide active noise reduction (ANR). In various implementations, control of sound source output is performed using an ANR system that enables selective pass-through (also called “transparency), cancelation, or enhancement of signals from certain classes of sound source relative to others. In various particular examples, the audio device 20 includes an occluding headset that enables beneficial control of ANR and pass-through functions. The occluding headset may provide at least some passive noise reduction (PNR) via sealing and/or occluding the user's ear canal. A non-limiting example list of headsets offered by Bose Corporation (Framingham, MA, USA) include: the QuietComfort Ultra Headphones, the QuietComfort Headphones, the QuietComfort Earbuds, the QuietComfort Ultra Earbuds, and the Ultra Open Earbuds.

In certain cases, the audio device 20 includes one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In addition to processor(s) 50, the audio device 20 can also include one or more microphones 80 (e.g., a microphone array), and a transducer 90 (e.g., an electro-acoustic transducer) for providing an audio output, e.g., in space 5. Further, the audio device 20, can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). Certain of the above-noted components depicted in FIG. 1 are optional, and are displayed in phantom.

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, communication unit 60 is particularly suited to communicate with other communication units 60 in audio devices 20 and/or additional device(s) such as smart devices (e.g., smartphones, tablets, smart watches) via Bluetooth. In still further implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF) and/or a hard-wired connection, e.g., between any two or more devices.

In certain example implementations, additional devices 40 such as smart phones, smart watches, tablets, etc., in space 5 can include similar components (e.g., a processor 50 and communications unit 60) as the audio device 20. Further, those additional devices 40 can include additional components that may not necessarily be present at the audio device 30. Additional device(s) 40 can be configured to communicate with any device described herein.

Also shown in FIG. 1, one or more audio devices 20 and/or devices 40 can include an interface 110. In some cases, the interface 110 is a physical interface on the body of the device, although this is not necessary in all implementations. In certain cases, the interface 110 can include a touch screen, button, dial, slider, etc., that is configured to control one or more attributes of the audio device 20 (or devices 40) in a plurality of modes.

The audio device 20 can be configured to output audio from an audio source. In some cases, the audio source can include an audio gateway device such as device 40. In additional cases, the audio device 20 can be configured to output audio from an audio source via a network, cellular, and/or cloud-based connection, e.g., via a streaming music service, an internet radio station, a stored audio file library, etc. In various implementations, the audio device 20 can be referred to as a “smart” device that has network and/or cellular connectivity, and in certain cases, operate or otherwise execute virtual personal assistant (VPA) functions.

As described herein, the audio device 20 and/or the device 40 can be referred to as an audio capture device. That is, the audio device 20 and/or device 40 can include a microphone 80 that is configured to capture audio from the space 5, e.g., a natural language command (e.g., voice command) from a user in the space 5. In certain cases, the microphone 80 is integrated into the audio device 20 and/or device 40, and/or is a separate component coupled with the processor 50, e.g., a microphone accessory or accessory device including a microphone. In any case, one or both of the audio device 20 or device 40 can act as an audio capture device as described herein.

Further, the audio device 20 and/or device 40 can be configured to receive additional command inputs and/or detect additional inputs, for example, text inputs by the user, user inputs detectable at one or more sensors (e.g., capacitive touch sensors, IMUs, etc.), and/or inputs from one or more sensors at the audio device 20 and/or device 40 (e.g., camera inputs detecting features in the environment 5). In various implementations, the inputs to the ML model 30 can be based on multi-modal inputs from the audio device 20 and/or device 40, e.g., two or more of voice, camera, IMU, contextual cue, etc.

### Sound Source Detection and/or Selection

As noted herein, in particular cases, the processor 50 is configured to provide ambient sound source selection functions to beneficially adjust output of at least one class of ambient sounds relative to another class of ambient sounds. In some aspects, the class-based adjustment is controlled by a user input (e.g., user selection and/or inputs from one or more contextual cues of device usage). In still further implementations, the processor 50 is configured to detect sound classes in ambient noise, e.g., for training a model such as ML model 30 and/or for instructing ML model 30 to assign device settings based on the detected sources.

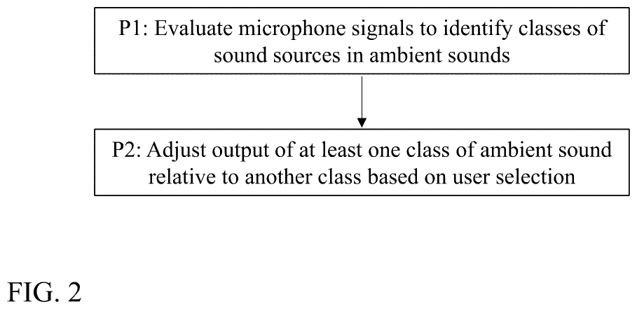

FIG. 2 is a flow diagram illustrating processes in a method of content class-based control performed by processor 50, e.g., a processor at a wearable audio device such as an occluding audio device. In certain cases, the processor 50 is configured to:
P1: evaluate microphone signals from microphone(s) 80 to identify classes of sound sources in ambient sounds (or, ambient acoustic signals); and
P2: adjust output (e.g., at transducer 90) of at least one class of the ambient sounds relative to another class of ambient sounds based on a user input.

It is understood that adjusting output of the at least one class of ambient sounds can include separating the identified (and detected) classes of sound sources. For example, source separation can be performed as part of (or a preceding step to) adjusting the output of one or more of the identified classes in the microphone signals.

In some cases, the user input includes an affirmative selection of a class or classes of ambient sounds. In other cases, the user input is based on an inferred intent of device usage, for example, based on inputs from one or more sensors, past device usage, user profile information, time of day, etc.

In particular cases, the processor 50 is configured to evaluate microphone signals from microphone(s) 80 when operating in a content class-based control mode. In some cases, this mode is selected as a default operating mode. In other cases, the content class-based control mode is entered in response to a trigger, e.g., a user interface actuation, a device state change, a power cycling event, a usage pattern or usage indicator, etc. In further implementations, the content class-based control mode is entered in response to detecting one or more ambient sounds in microphone signals that may benefit from selective classification control.

In particular cases, the processor 50 is configured to identify at least one of the following classes of sound source in the ambient sounds: i) nearby voice, ii) alerts and sirens, iii) nearby transit, iv) out loud music, v) background sounds, vi) nature (also called “natural) and animals. In some cases, background sounds include machine sounds, steady environmental sounds, etc. These example classes of sound source are non-limiting, and only intended to illustrate various disclosed aspects.

In some cases, sound sources are identified and/or differentiated by at least one acoustic characteristic, e.g., frequency, spectrum, spectral peak and/or range, sound pressure level (SPL), etc. In particular cases, a Mel-frequency spectrogram is used to recognize specific categories of sound events based on value. For example, various disclosed implementations utilize a ML model 30 that is trained to recognize specific classes (or categories) of sound based on their associated values in a Mel-frequency spectrogram.

In certain aspects, the user input (e.g., selection) of audio class/classes is provided via a command, e.g., language-based command such as a natural language (NL) command. In some cases, the NL command includes a voice command, a text command, and/or an input from one or more device sensors/systems. Features of NL based processing of input commands is discussed further herein, e.g., with respect to ML model 30. In additional aspects, user input is provided via a user profile command. For example, a user profile (such as a default profile or a profile that has been modified or otherwise tailored by a user) can include profile commands that control ambient sound class selection. One or more profiles can be stored at audio device 20, e.g., for use by processor 50. In further aspects, user selection is a default user selection at startup of the audio device 20, e.g., at an initial startup of the audio device 20. The user input can also be a factory setting for the audio device.

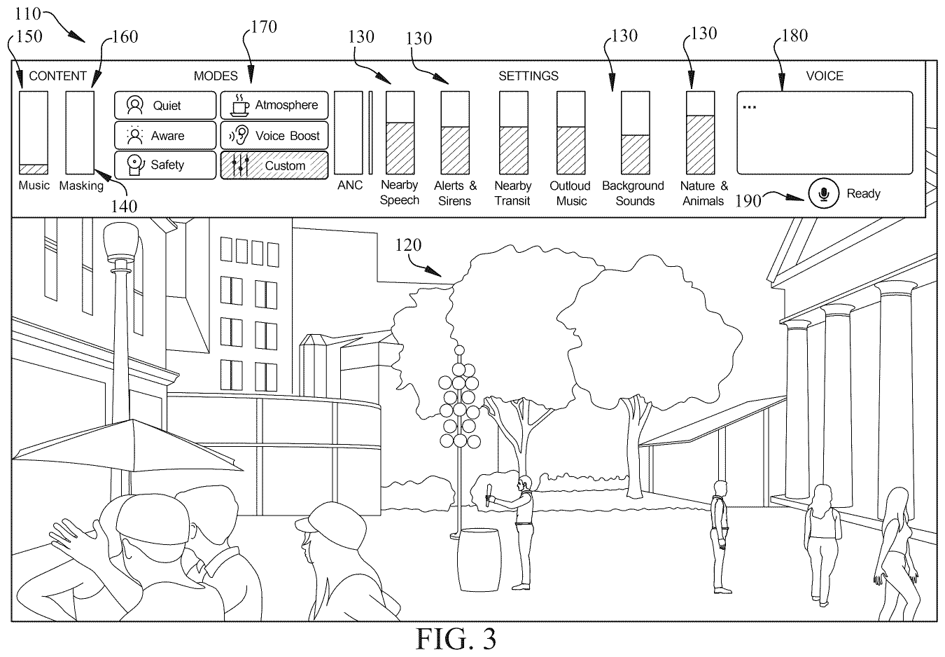

In still further, implementations, user input is provided via an interface, e.g., a visual interface provided at the audio device 10 or another connected device 40 (e.g., a smart device). For example, FIG. 3 illustrates an example interface 110 enabling options for sound source selection by a user. Interface 110 can depict a scene 120 in some examples, e.g., to illustrate the various sound sources that may be present in an environment. In some example depictions (e.g., FIG. 3), classes of sound source 130 are indicated in the example Settings depiction, including: i) nearby voice (or speech), ii) alerts and sirens, iii) nearby transit, iv) out loud music, v) background sounds, vi) nature (also called “natural) and animals. In particular cases, the interface 110 (or another similar interface) can enable per-class adjustment to classes ambient sounds 130, e.g., via enhancement and/or ANR. Per-class adjustments can be controlled via commands on the audio device 20 and/or a connected device 40, such as button or touch interface commands. Per-class adjustments can also be controlled via interface 110 (or another similar interface), e.g., via sliders, toggles, buttons, dials, etc., to adjust enhancement or ANR application to classes of ambient sounds 130.

In further implementations, user inputs are based on device 20 usage and/or activity, and do not require an affirmative input by the user. For example, natural language style commands can be auto-generated by detecting activity. For example, the processor 50 can be configured to receive inputs such as device state inputs, inputs from one or more sensors, etc., to detect user activity and/or infer commands for sound source selection. For example, the processor 50 can receive location inputs from BT module 70 (e.g., proximity-based inputs), a WiFi module, and/or a location module that indicate the audio device 20 is in a particular location. Further, the processor 50 can receive acoustic inputs, e.g., microphone inputs 80 that indicate sound sources indicative of a particular activity and/or location. Additionally, the processor 50 can receive sensor inputs from one or more sensors (e.g., in additional electronics 100) that provide contextual cues for inferring user intent in device settings. Examples of such sensor inputs can include IMU inputs and/or optical sensor inputs indicating that a user is walking, running, stationary, moving consistently or intermittently, etc.

In particular examples, the processor 50 is configured to receive inputs from one or more sensors at device 20 (and/or device 40), and convert those inputs into a natural language input to a decision engine (e.g., ML model 30) for selecting device settings based on inferred user intent. For example, the processor 50 can detect one or more indicators that a user is cooking (e.g., acoustic inputs from microphones 80 that indicate frying, boiling water, or noise from pots and pans, time of day inputs, location inputs indicating the user is in the kitchen, etc.) and send a natural language input to an ML model 30 for device setting selection. In this example, the processor 50 detects that the user is cooking (e.g., via one or more inputs from microphones 80, sensors in electronics 100, and/or contextual cues from the operating state of the device 20), and sends a natural language input to the ML model 30 (e.g., “I am cooking, please choose my cooking settings.”) to prompt adjustment of at least one device setting (or, maintaining the at least one device setting) based on the input.

Further, the interface 110 can enable selection between levels of content 140, e.g., playback 150 such as music, podcast or radio audio, audio for video-based audio, and masking 160 (e.g., the level of ANR applied to ambient sound). The interface 110 can also enable selection of one or more modes 170 in which the processor 50 is configured to operate. Modes may provide predefined mixes of class-based settings to the user for selection. In some non-limiting examples, the processor 50 is configured to operate in modes 170 including: a) quiet mode, b) aware mode, c) safety mode, d) atmosphere mode, e) voice boost mode, or f) custom mode.

It is understood that “enhancement” as described herein can include improvement in one or more features of audibility in the output signal to improve the likelihood that the user receives the target portion of the output signal. In various implementations where the audio device 20 is an occluding wearable audio device, enhancement is performed as part of the transparency or hear-through signal path that receives ambient acoustic signals via microphones 80 and recreates those inputs as outputs in a parallel path to audio playback and/or streaming content.

In particular implementations, enhancement is performed using source separation and/or denoising. For example, a mask (e.g., set of attenuation values) is applied to each time-frequency frame of the noise signal to enhance the output of that signal. A large amount of attenuation can be applied to frames that are predicted to be in the target (e.g., desired) class. In certain cases, these masks are generated using a ML model, e.g., via artificial intelligence (AI) based source separation and/or AI based denoising. Such masks can be generated in real time based on acoustic signal inputs to the ML model.

In further examples, the ANC (or, ANR) system at processor 50 is configured to operate in at least two modes. In both, the ANC system runs at the maximum possible level (most cancellation) to provide a “blank canvas”, or cleanest starting point. Processor 50 can then use one of two example methods to layer environmental sounds back in, selectively (e.g., similar to how streamed music is layered on top of the ANC system). Example Case 1: the processor 50 trains individual models to enhance specific sounds, e.g. voice. When this model or models (e.g., sound enhancing neural network) is selected, voices are passed through while other sounds are attenuated. The processor 50 can then utilized multiple purpose-built enhancement models that it cycles between, or even mixes the output of, to deliver that filtered output to the user via transducer(s) 90. Example Case 2: processor 50 strain a model (e.g., source separating neural network) to separate environmental sounds into multiple classes. The processor 50 then determines what level of each class should be presented given user intent (e.g., inputs, cues, etc.)e, and mixes those outputs accordingly. That mixed output becomes the filtered signal delivered to the user via transducer(s) 90.

With continuing reference to interface 110, a quiet mode (a) may provide a high level of attenuation (in some cases, active noise reduction (ANR)) across all classes of sound source 130, e.g., reducing the noise detected by the user of the audio device 20.

An aware mode (b) may provide a high level of pass-through (or transparency), by preserving a plurality of sound sources 130 output to the user as audio output, e.g., enhancing output of all noise detected by the microphones 80.

A safety mode (c) may provide a high level of ANR similar to quiet mode (a), but selectively enhance sound sources relating to safety, e.g., alerts and sirens, nearby transit, and/or nature and animal sounds.

An atmosphere mode (d) may apply a first level of attenuation to select classes of sound source 130 such as unpleasant or disruptive sounds, e.g., alerts and sirens, nearby transit, and/or out loud music, and apply a second level of attenuation to distinct classes of sound source 130 such as nearby speech, background sounds, and/or nature and animals. In some cases, the second level of attenuation is lower than the first level of attenuation. In this example, a third (e.g., lower) level of attenuation can be applied to background sounds and/or nature and animal sounds while the second level of attenuation is applied to nearby speech. Further, enhancement (e.g., volume enhancement, spectral filtering, etc.) can be applied to nearby speech, background sounds and/or nature and animal sounds in various implementations.

A voice boost mode (e) may apply a first level of attenuation to sound sources 130 that do not include nearby voice (speech), for example alerts and sirens, nearby transit, out loud music, background sounds, and nature and animals. In certain examples, distinct levels of attenuation can be applied to distinct sound sources 130 based on a likelihood to interfere with nearby voice sounds. In this mode, nearby voice signals can be enhanced, e.g., in terms of volume, spectral filtering, etc., to enable the user to better hear voices of nearby talkers (or other voice sources).

Further, a custom mode (f) is shown as selectable via the interface 110, whereby a user can select attenuation and/or enhancement settings for one or more of the sound sources 130. The user may select settings for one or more sound sources 130 to be applied in real time, and/or saved in a profile and/or device settings for application at a later time.

In additional implementations, the interface 110 can also include a voice-to-text display 180 enabling a user to select a record function 190 and transcribe text detected by microphones 80 in the display 180. In particular cases, in response to the user actuating the record function 190, the processor 50 applies voice boost mode (e) or similar settings to enhance nearby speech content relative to at least one other sound source 130, and records speech detected by microphones 80. In one example, the record function 190 is a button the user presses to initiate listening to her voice input. In some examples, actuating record function 190 triggers a temporary reduction of all sounds sent to the user's ears, so the user can speak with less distraction, as if she were conversing with an AI assistant. In some cases, the user presses the record function 190 again to end the interaction. The speech can be converted to text and displayed in display 180 so that the user can see what the system “heard” or interpreted, e.g., to mitigate transcription errors. Such a voice-to-text display 180 is optional in various implementations, and voice interaction could be initiated via simply speaking, or via wake word, or device interaction, etc.

While interface 110 is described according to some examples, it is understood that the processor 50 can be configured to automatically select one of the plurality of modes (e.g., modes (a)-(f)) for selective sound source control based on contextual indicator(s) and/or usage indicator(s). In various implementations, this automatic selection is performed without a user input command (or without user confirmation command). In certain of these cases, the processor 50 evaluates contextual indicator(s) and/or usage indicator(s) of the audio device 20 and/or connected device(s) 40 and applies mode(s) to selectively adjust output of at least one class of ambient sounds 130.

For example, contextual indicators may include environmental context such as types of sounds detected by microphones 80 that characterize the environment in which the user is located. In one example, contextual indicators in a coffee shop may include background sounds such as sounds of an espresso maker, steamer, coffee grinder, door opening/closing, out loud music sounds, and/or a variety of distinct nearby voices. Contextual indicators in a sports arena may include large variation in out loud music and background sounds, with consistent levels of nearby voice (speech) content. Contextual indicators in a train station may include consistent levels of background sound, transient nearby voice sounds, little or no nature or animal sounds, and frequent alerts or sirens. Based on one or more contextual indicators, the processor 50 can be configured to select one or more sources 130 for enhancement and/or reduction in the audio output at transducer 90.

Further, the processor 50 can be configured to select sources 130 for enhancement and/or reduction in the audio output at transducer 90 based on usage indicator(s) of the audio device. Usage indicators can include usage data about the audio device 20, device state data (e.g., on, outputting audio, sleep mode, listening mode, paired with X, etc.) about the audio device 20, data about the known or likely user (e.g., based on proximity of a user device 40 such as smart phone to the audio device 20), user profile data about a user assigned to the audio device 20, data about location of the audio device 20 (e.g., in a transit vehicle), data about the type of audio device 20 (e.g., soundbar v. portable audio device v. headphones), time of day, prior and/or last-paired device data for a device paired to the audio device 20, etc.

In additional implementations, as noted herein, the processor 50 can provide interface options including a natural language (NL) based control mode, whereby at least one class of sound source 130 is selected for adjustment by a user command. In certain examples, as described herein, while operating in in the NL based control mode, the processor 50 is configured to: I) convert the user command into a natural language input; and II) provide the natural language input to a machine learning (ML) model for identifying the at least one class of sound sources 130 based on the natural language input. As noted herein, in various example implementations, the natural language input need not include or be preceded by a wake word.

### Large Language Model (LLM) Based Control of Device Function(s)

With continuing reference to FIGS. 1-3, in particular cases the processor(s) 50 may, for example, enable control of one or more actions using ML model 30. In particular cases, processor(s) enable natural language (NL) based control of one or more actions using ML model 30, e.g., including a LLM. In certain cases, the ML model 30 is at least partially located at the audio device 20 and/or the device 40 in the space 5 (FIG. 1). For example, the ML model 30, or a version thereof, can be run or otherwise stored or operated locally at the audio device 20 and/or the device 40. In additional implementations, the ML model 30 is stored, operated, updated, or otherwise managed in a remote location 200, such as a centralized or distributed computer network or a cloud-based computer network or system. In particular implementations, the ML model 30 is periodically updated in the remote location 200, e.g., with training and/or refinement data. In certain cases, the ML model 30 is configured to be run at the remote location 200. In additional cases, a distinct, local version of the ML model 30 is configured to be stored and/or run at the audio device 20 and/or device 40.

In various implementations, processor(s) 50 in audio device 20 and/or device 40 include a (voice) routing control module which can include software and/or hardware for performing control processes described herein. For example, processor(s) 50 can include a voice routing control module in the form of a software stack having instructions for adjusting the attribute(s) of the audio device based on interaction with the ML model 30 according to any implementation described herein. Examples of such attributes can include class-based source adjustment in audio output (e.g., playback). However, other attributes can also be controlled via voice routing as discussed further here.

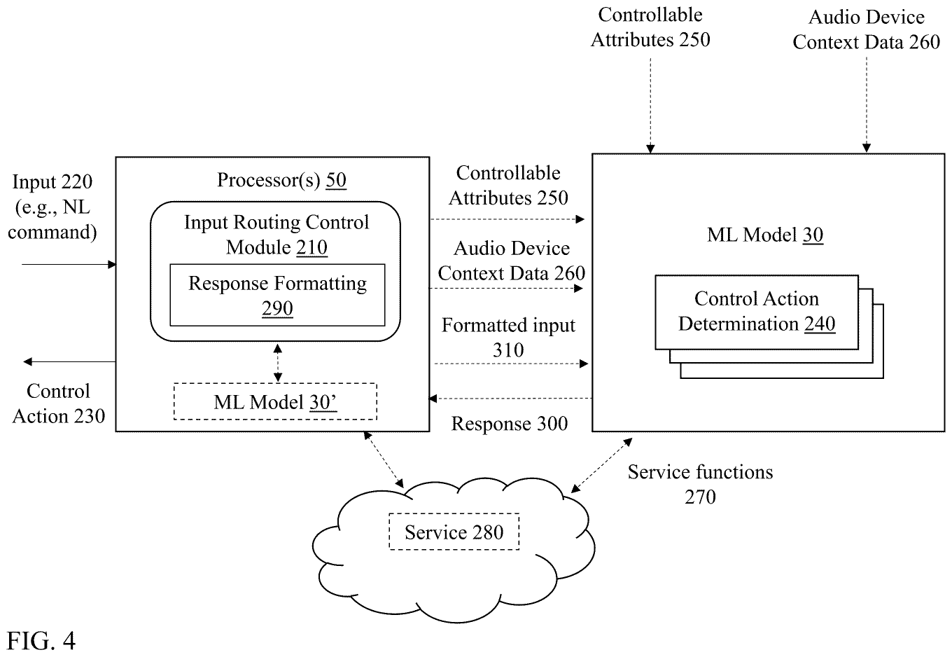

FIG. 4 is a schematic data flow diagram illustrating interaction of the processor 50 including a user input (e.g., voice, text, gesture, sensor input, and/or inferred inputs) routing control module 210 that interfaces with the ML model 30 to determine a control action for at least one attribute of an audio device. In particular implementations, the ML model 30 includes an artificial intelligence engine that includes one or more neural networks, e.g., advanced neural networks (ANNs). In one example, the neural network(s) include a temporal convolutional network (TCN) and/or a convolutional long short term memory (ConvLSTM) network. In particular implementations, the ML model 30 includes a large language model (LLM) and/or a large action model (LAM) that is configured to determine a control action for one or more attributes of the audio device 20 based on user input, e.g., a voice input, a text input, a gesture input, an/or an input from one or more sensors at the audio device 20 that provides inferred user intent. In particular cases, the ML model 30 includes one or more models with a set of non-linear pathways defined as sequences of steps between distinct sets of parameters. In particular cases, the LLM and/or LAM differs from a database used by conventional virtual personal assistants, in that those conventional database systems require natural language (NL) inputs and training to infer a user's intent and decide on a response. As noted herein, various implementations of the ML model 30 and related approaches of the processor 50 do not require training to infer intent and select a response. Further, conventional virtual personal assistants require a wake word to process the NL input. In some cases, the ML model 30 and processes performed by the processor 50 do not require a command (e.g., button press, wake word, or other trigger) to process a user input and provide a response/action. In other implementations, a trigger command (e.g., wake word, button press, mode selection command) is used to initiate processing of a user command (e.g., a natural language command).

As noted herein, the ML model 30 can be implemented in a local (e.g., on device 20) configuration and/or in a remote (e.g., at distinct device 40 and/or cloud-based) configuration. In some cases, a user input (e.g., NL input) 220 is provided to a large ML model 30 such as a LLM or LAM that is capable of processing those inputs 220 into actions. In other cases, a user input (e.g., NL input) 220 can be sent to a “light” or reduced complexity ML model 30′ on device 20 (or in the cloud) that detects sound events, and makes decisions to act based on this detection. In these cases, the ML model 30′ can include an ConvLSTM or TCN, for example.

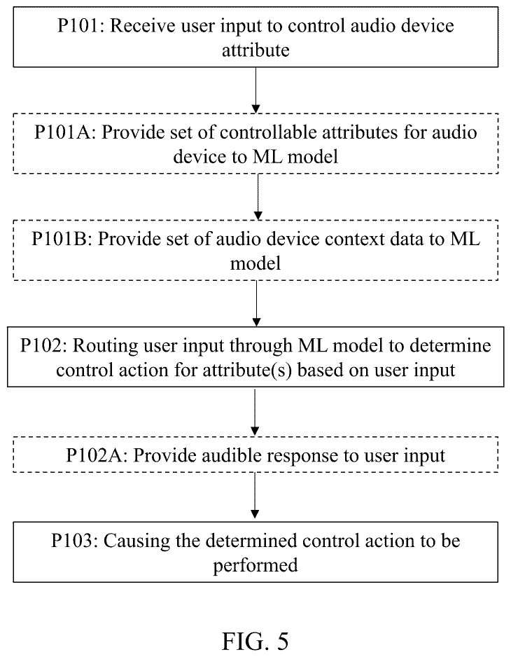

With continuing reference to FIG. 4, and additional reference to the process flow diagram in FIG. 5, approaches according to various implementations can include:
P101: receiving user input 220 to control at least one attribute of the audio device 20. In certain cases, as noted herein, the user input 220 includes an input from one or more sensors at device 20 and/or device 40. In certain cases, user input 220 is captured as a voice input, text input, or other sensor input at audio device 20 and/or device 40. Further, as noted herein, user input 220 can also be generated by audio device 220 without affirmative selection by the user of audio device 20, for example, these NL user inputs 220 can be generated based on one or more contextual inputs to infer user intent in usage of the audio device 20. As noted herein, contextual inputs can be provided by one or more sensors at audio device 20 (e.g., microphones 80, interface(s) 110, electronics 100 including IMUs and cameras, proximity detection, time of day, calendar information, usage patterns, etc.). Contextual inputs can be used (with or without affirmative inputs from the user, such as via interface 110) to infer user intent in operation of the audio device 20. Contextual inputs can be multi-modal, for example, providing enhanced confidence in selection of inputs 220.

In certain implementations, such as where input 220 includes a voice input, the audio capture device 20, 40 performs the listening without requiring a wake word. For example, the audio capture device 20, 40 can be in a default listening mode for user input to control the attribute(s) of the audio device 20. In additional implementations, the audio capture device 20, 40 detects a wake word (e.g., “Hey, Assistant”) prior to receiving the user input. In some aspects, the audio capture device 20, 40 performs the listening after detecting a user command. In particular examples, the user input 220 (or, user input command) includes at least one of, a wake word (e.g., detected via microphone(s) 80), a button press (e.g., as detected via interface 110), or a user interface actuation (e.g., as detected via interface 110).

In certain implementations, the user input 220 relates to controlling one or more attributes of the audio device 20. In some examples, the attributes include one or more of: audio class selection from ambient noise, playback control functions, transport control functions, active noise reduction (ANR) control functions, connectivity control functions, playback source control functions, or audio setting control functions.

In other implementations, user input 220 can relate to controlling additional attributes of the audio device 20 and/or a plurality of audio devices 20, 20A, 20B, etc. that include audio device 20, e.g., coordinating playback, volume level, channel selection, or grouping of additional audio devices 20A, 20B, etc. As noted herein, additional audio devices 20A, 20B, etc., can be connected with or otherwise communicate with audio device 20, and can perform coordinated functions in certain implementations. Additional examples of multi-device controls are described, e.g., in U.S. patent application Ser. No. 18/387,144 (“Audio System Control Device”, filed Nov. 6, 2023) and Ser. No. 18/385,997 (“Dynamic Portable Speaker Grouping”, filed Nov. 1, 2023), each of which is incorporated by reference in its entirety.

Returning to FIGS. 4 and 5, process P102 can include routing (using input routing control module 210) the user input 220 through the ML model 30 to determine a control action (e.g., as control action instructions) 230 for the attribute(s). In particular cases, the ML model 30 includes a control action determination module 240 that is configured to determine the control action 230 for the audio device 20 based on the user input 220. In particular cases, the control action determination module 240 is configured to determine a control action 230 based on controllable attributes 250 and/or audio device context data 260, as described herein.

In particular examples, as illustrated in phantom in FIG. 2 as optional, the processor 50 provides a set of controllable attributes 250 for the audio device 20 to the ML model 30. In certain cases, the set of controllable attributes 250 are provided to the ML model 30 with the user input 220, as illustrated in phantom as process P101A in FIG. 3. In other implementations, the controllable attributes 250 for the audio device 20 are provided to the ML model 30 prior to listening for the user input in process P101. In certain cases, the controllable attributes 250 are defined in terms of an application programming interface (API), e.g., JSON.

In one non-limiting example, controllable attributes 250 are provided as a prompt. One example of such a prompt for controlling an audio device 20, e.g., a headphone, can be provided as a text file or other file readable in text format with content including:

“You are a system in a headphone that controls how audible different categories of sounds should be to the user based on their prompt. Assume that all sounds are present in the user's environment but they want to hear some more than others. Please respond to each valid prompt with a JSON blob where each category is a key and the value is the relative loudness of that category (in dB FS, −50 to 0). If you determine that the prompt is completely unrelated to the audibility of different sound categories, then respond with an empty JSON blob. The complete list of sound categories, in this order, includes: nearby speech, alerts (like alarms and sirens), nearby transportation (like cars, buses, or machines), out loud music, background sounds (like ambient sounds, babble, distant car or airplane sounds), and nature (including animals and weather). Also, the user may be listening to streamed music or a podcast. So if the request includes ‘my music’, this is different than the music in their environment.” The above example prompt is just one of many variations that can define controllable attributes 250 for the audio device 20 in a format readable by the ML model 30.

In certain examples, the process of routing the user input 220 through the ML model 30 includes defining a format of a response 300 from the ML model 30, e.g., using a response formatting module 290. In certain implementations, the response formatting module 290 converts the user input 220 into a formatted user input 310 that includes the context of the user input 220 along with format characteristics of the response 300. In one example, the format includes an object-based format such as JSON. In particular cases, the formatted user input 310 includes one or more keys for indicating a response 300 based on one or more decision layers. For example, the formatted user input 310 can include at least three distinct sets of decision layer keys, which may correspond with distinct layers of the ML model 30, e.g., one or more layers in the control action determination model 240. In one example, the control action determination model 240 includes a plurality of layers corresponding with: i) top level decisions (action routing), ii) wearable audio device type controls (e.g., where audio device 20 is a wearable audio device), iii) speaker or out-loud audio device type controls (e.g., where audio device 20 is a speaker intended to provide out-loud audio), iv) system state changes, v) external API response selection controls (e.g., in selecting responses from a service 280), and/or vi) text summarizer controls.

In one example, action routing (i) can include JSON responses with keys such as “Action”, “Data”, “FriendlyResponse”, etc. For example, Actions can include audio related controls (e.g., adjustment of relative classes of sound source 130), music related controls, movement of audio devices 20 (e.g., within space 5 or into/out of space 5), changing the state of a group of audio devices 20, and a No Match action. In certain cases, a No Match action is associated with a FriendlyResponse that includes a follow-up query such as a voice assistant-based question or request for information. A Data key can indicate a string of tasks as being completed.

In another example, a wearable audio device type control (ii) and/or a speaker type control (iii) can include similar response key categories such as “Action”, “Data”, “FriendlyResponse”, and can include a formatting requirement such as requiring that all JSON keys are included in the response 300. Further, the controls (ii) and/or (iii) can include a volume range identifier (e.g., from 0 to 100). A Data response can include replacing any X, Y, or Z found in an action and creating a list in the order of X, Y, then Z. A FriendlyResponse can include a brief description of the action being taken. Actions can include one or more of: play, pause, next track, previous track, restart track, repeat off, repeat track, repeat context, toggle shuffle, play on audio device X, play on all speakers, improve audio quality, speaker capabilities, battery level, grouping, add audio device X to group, remove audio device X from group, change in location of audio device X, like a song/track/stream, volume up, volume down, volume up by X, volume down by X, set volume to X, mute, unmute, get current track, play a playlist, search for or play a playlist, song, or music by an artist, add a song to a queue, search for lost audio devices, toggle immersion mode, toggle noise cancelation mode, toggle aware mode, move music in space (spatial audio controls), device setup instruction, speaker placement guidance, set EQ to match activity or audio source features, etc.

In another example, a formatted input 310 including an external API response selection (v) includes a search key with a list of strings associated with one or more services 280, e.g., internet radio services, streaming services, audio content storage services, etc. This formatted input 310 can request the response 300 as a best match to one of the strings in the key.

In another example, the text summarizer controls (vi) include a formatted input 310 that defines the response 300 as a FriendlyResponse in sentence or phrase form, based on the user input 220.

In particular implementations, the FriendlyResponse described herein can include an audible response such as a voice assistant response in sentence or phrase form. In particular cases, the FriendlyResponse includes an audible response intended to elicit a follow-up user input 220, e.g., to refine and/or adjust a subsequent user input 220 and corresponding response 300.

In some examples, the user input 220 is compared to the controllable attributes 250 (e.g., a controllable attribute group) by the control action determination model 240, and if a match exists, a positive response is provided with an audible response related to the control action 230. In particular cases, controllable attributes 250 are separated into distinct groups or segments. For example, a positive response can include a chime, ring, or other sound, a visual indicator such as a light or color change in a display (e.g., change to green), a vibro-tactile response such as a vibration, and/or a voice assistant response such as, “Adjusting control attribute X” or “Thank you for your input, adjusting control attribute Y now.” In further examples, if no match exists, a null or negative response is provided, which can take any of the forms of a positive response, and may include a distinct color (e.g., red), distinct chime or sound, or a voice assistant response such as, “No match found” or “Sorry, I cannot understand that command.” In certain cases, the null response is used to determine which controllable attribute is desired to be modified. For example, by separating controllable attributes into groups or segments, null responses for particular groups or segments can aid in identifying the intended attribute, e.g., increasing the accuracy of the response. In such cases, null responses can be used to identify unintended attributes and refine the user's subsequent responses to enhance the chances of identifying the indented attribute.

In some implementations, as shown optionally in process P101B in FIG. 3, the method can further include providing a set of audio device context data 260 to the ML model 30 for use in determining the control action 230 for the at least one attribute 250. In some cases, the audio device context data 260 can include: usage data about the audio device 20, device state data (e.g., on, outputting audio, sleep mode, listening mode, paired with X, etc.) about the audio device 20, data about the known or likely user (e.g., based on proximity of a user device 40 such as smart phone to the audio device 20), user profile data about a user assigned to the audio device 20, data about location of the audio device 20 (e.g., in the kitchen), data about the type of audio device 20 (e.g., soundbar v. portable audio device v. headphones), time of day, prior and/or last-paired device data for a device paired to the audio device 20, etc. In certain examples, context data 260 can be provided to the ML model 30 with the user input (e.g., with process P101) or ahead of time (e.g., prior to process P101).

In particular cases, a control action 230 can include a change in an attribute 250 of the audio device 20 and/or maintaining an attribute 250 of the audio device 20. In particular examples, controlling attributes 250 of the audio device 20 can include controlling functions of the audio device 20 such as one or more of, transport control, volume of audio output, active noise reduction (ANR), audio device grouping, equalization of audio output, spatial audio controls (e.g., motion versus still, or object-based audio controls), transparency mode (e.g., on a wearable audio device), or channel playback (e.g., stereo, left/right, coordinating channels with another speaker, and/or party mode).

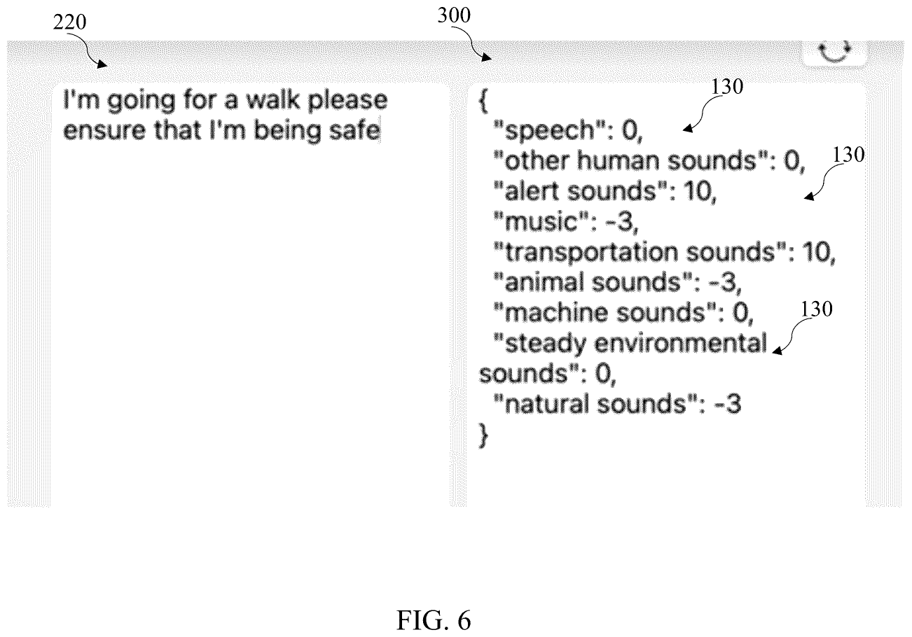

In a particular example, the control action 230 can include adjusting output of at least one class of ambient sound 130 relative to another class of ambient sound based on the user input 220. FIG. 6 depicts an example user input 220 and corresponding response 300 from ML model 30 in controlling ambient sound classes 130 according to particular implementations. In this example, the user input 220 is the natural language phrase, “I'm going for a walk please ensure that I'm being safe.” The ML model 30 response 300 includes Settings levels (or values) that correspond with distinct ambient sound classes 130, including but not limited to: speech, other human sounds, alert sounds, music, transportation sounds, animal sounds, machine sounds, steady environmental sounds, and natural (nature) sounds. In this particular example, the ML model 30 can be configured to parse and analyze the NL phrase to key one or more words or sub-phrases, e.g., going, walk, please, ensure, safe, with particular attention to words such as “walk” and “safe.” In this example, the ML model 30 response 300 defines settings for sound classes 130 to enhance alert sounds and transportation sounds, while increasing cancelation (e.g., actively canceling) of nearby (or, ambient) music, animal sounds, and natural sounds. Certain other sound classes 130 not likely to be present or otherwise not detected are not adjusted in this example, e.g., machine sounds, steady environmental sounds, and other human sounds. While response 300 shows values assigned to distinct sound classes 130, it is understood that the response 300 can be formatted according to input 310 to provide a control action 230 that is compatible with processor 50, e.g., adjustments (e.g., +/− indicators for a given sound class 130), on/off indicators for one or more sound classes 130, and/or relative settings of sound classes 130 (e.g., maintain alert sounds and transportation sounds above speech and machine sounds).

In another example, a user is walking through a town square where a street performer is playing music. In this case, the user input 220 can include the natural language phrase “I want to hear that busker.” In particular implementations, audio device context data 260 can indicate a location of the user, as well as the fact that the audio device 20 is moving (e.g., at a walking pace). The ML model 30 response 300 includes settings levels (or values) that correspond with distinct ambient sound classes 130, e.g., to enhance (ambient) music, enhance other human sounds, and reduce (e.g., cancel) natural sounds, machine sounds, and/or transportation sounds. In this example, music sounds can be set to a level 10 and nearby voice sounds set to a level 7, while transportation sounds, machine sounds, and steady environmental sounds are set to a level zero. Natural sounds may be canceled, along with animal sounds, e.g., at level −3. In this sense, the user voice command acts to cancel competing sounds with the street performer, and enhance sounds attributed to the street performer.

In another example, a user is on a phone call (experiencing call audio at audio device 20) or listening to a podcast (experiencing streaming or downloaded audio playback at audio device 20), and provides a natural language user input 220 (captured at microphone(s) 80) of, “don't interrupt me unless it's Penny and she might need to get out.” The user is asking audio device 20 not to interrupt unless the pet dog, Penny, makes noise indicating she may need to be let out. In this example, audio device context data 260 may indicate that the user is currently listening to audio (e.g., music, podcast, etc.) at the audio device 20, which may be the subject of an interruption. Further, the audio device context data 260 may indicate that the user (via audio device 20) is in a static location, or at least not undergoing significant changes in position/location. The ML model 30 can be configured to parse and/or analyze the NL user input 220 and detect key words, phrases, or cues, e.g., “interrupt,” “need to get out,” and “Penny.” For example, the ML model 30 can infer that Penny is a pet, and can provide a response 300 that adjusts one or more ambient sound classes 130 to enhance the chances of detecting Penny. In a particular example, the response 300 adjusts settings for output of ambient sound classes 130 to enhance animal sounds (e.g., by setting to a level 10) while canceling background sounds and nearby transit sounds (e.g., setting each to level −3). In other cases, the response 300 defines settings for output of ambient sound classes 130 to enhance animal sounds (e.g., setting to level 10) while canceling all other sounds (e.g.., to level −3).

While the above examples are characterized as including a NL user input 220, it is understood that user inputs (e.g., to the ML model 30) can be generated based on inferred intent. That is, the NL user inputs 220 described according to any example herein can be automatically generated by the processor 50 based on one or more contextual cues, e.g., usage cues of the audio device 20 and/or user. As described herein, contextual cues can provide the basis for inferred intent. In certain cases, the processor 50 (along with any ML model described herein, e.g., ML model 30′) can learn a user's inferred intent over time, e.g., with continued usage of device 20. Further, in some cases, a version of ML model 30′ stored at audio device 20 can learn (e.g., codify) patterns of usage cues for automatically generating NL inputs 220 to the ML model 30 that is run off-device.

### Inferred Input Examples

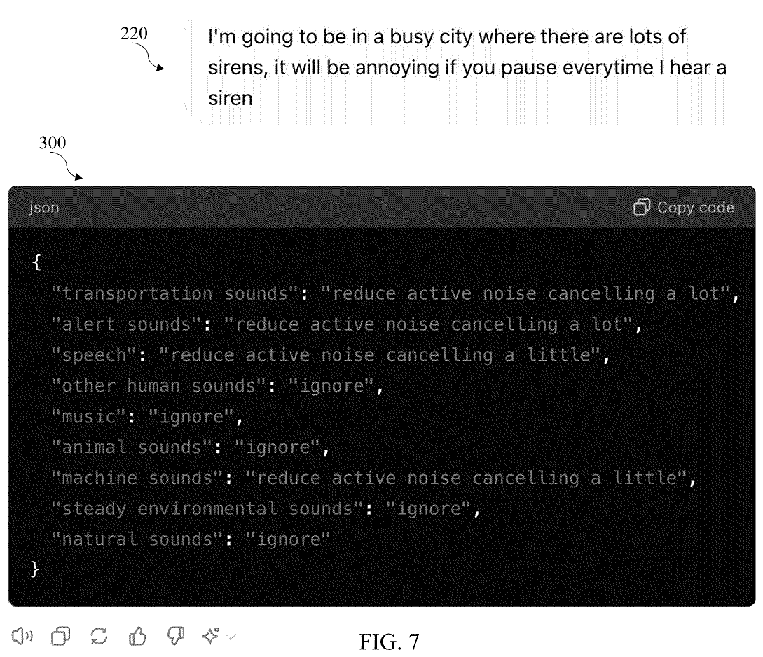

As noted herein, in addition to selectively adjusting ambient sound classes 130, the ML model 30 can be used to control additional functions of the audio device 20, e.g., by adjusting noise cancelation for particular sound classes 130, ANR controls, and/or playback controls. FIGS. 7-9 illustrate distinct NL user inputs 220 to a ML model 30 according to various implementations, with corresponding responses 300 formatted (e.g., in JSON) for execution by the audio device 20 in controlling one or more audio device functions. In these cases, NL user inputs 220 can be generated without affirmative selection by the user of audio device 20, for example, these NL user inputs 220 can be generated based on one or more contextual inputs (or, cues) to infer user intent in usage of the audio device 20. As noted herein, contextual inputs can be provided by one or more sensors at audio device 20 (e.g., microphones 80, interface(s) 110, electronics 100 including IMUs and cameras, proximity detection, time of day, calendar information, usage patterns, etc.). Contextual inputs can be used (with or without affirmative inputs from the user, such as via interface 110) to infer user intent in operation of the audio device 20. Contextual inputs can be multi-modal, for example, providing enhanced confidence in selection of inputs.

Turning to the example of FIG. 7, shown is the input (prompt) 220, “I'm going to be in a busy city where there are lots of sirens, it will be annoying if you pause every time I hear a siren.” In some cases, the processor 50 infers this input 220 based on detecting user location in the busy city, calendar information indicating a meeting in the busy city, etc. Further, the processor 50 can be configured to infer the input 220 (or enhance the confidence interval for such an inference) based on the user listening to a podcast or music stream, or taking a phone call. In addition, the ML model 30 infers (e.g., from terms such as busy, city, sirens, annoying, pause, every time, and phrases such as “every time I hear”) that the user does not wish audio content (e.g., playback or streaming content) and/or communications audio (e.g., phone call) to be interrupted by sirens/alerts, machine sounds, or transportation sounds. The response 300 is formatted to adjust (e.g., reduce) ANR (or, active noise cancelling) on sirens/alerts, machine sounds, and transportation sounds (while maintaining ANR on other sources), enabling such sounds to be heard above other sound sources. In some cases, ANR can be reduced on certain sound classes 130 to function in a transparency (or near transparency, or hear-through) mode as though the user is not wearing an audio device 20 when those sound classes 130 are detected. Outputting such sound classes 130 at or near their hear-through levels allows the audio device 20 to provide beneficial safety functions (i.e., alerting user of potential danger) while limiting interruptions as requested by the user's NL input 220.

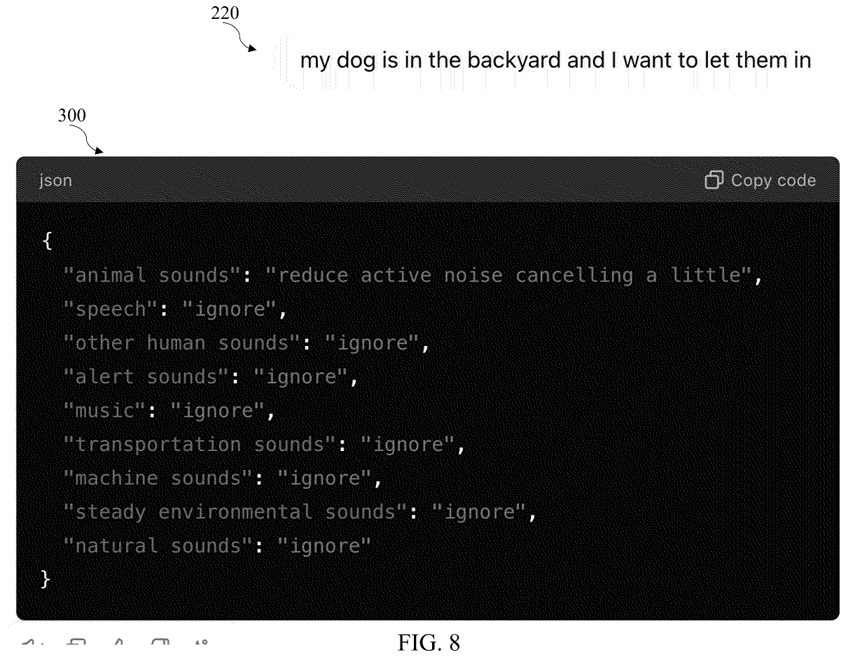

FIG. 8 shows the input (prompt) 220, “my dog is in the backyard and I want to let them in.” In some cases, the processor 50 infers this input 220 based on detecting user location in the their home, recent acoustic inputs of a dog barking and a door opening/closing, a usage pattern of letting the dog out while taking phone calls, etc. Further, the processor 50 can be configured to infer the input 220 (or enhance the confidence interval for such an inference) based on the user taking a phone call or having a meeting on his calendar. The ML model 30 can be configured to infer (e.g., from terms such as dog, backyard, let, them, in, I want) that the user wishes to detect his dog barking in the backyard during usage of the audio device 20, e.g., during playback or other audio output. The response 300 is formatted to adjust (e.g., reduce) ANR (or, active noise cancelling) on animal sounds (while maintaining ANR on other sources), enabling the animal sounds to be heard over other sounds (e.g., machine sounds, natural sounds, etc.) and in some cases, heard through as though the user is not wearing the audio device 20.

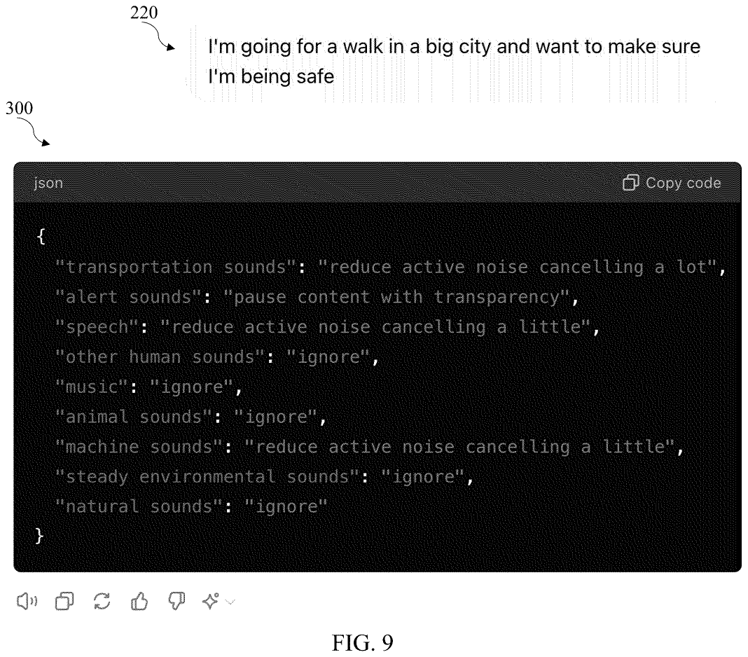

FIG. 9 shows the input (prompt) 220, “I'm going for a walk in a big city and want to make sure I'm being safe.” In some cases, the processor 50 infers this input 220 based on detecting user location in the big city, IMU activity indicating the audio device 20 moving at a walking pace, etc. Further, the processor 50 can be configured to infer the input 220 (or enhance the confidence interval for such an inference) based on the user taking a phone call or having a meeting on his calendar. Based on the input 220, the ML model 30 infers (e.g., from terms such as walk, big city, safe, make sure) that the user wishes to detect certain sound classes 130 during usage of the audio device 20, e.g., transportation sounds, speech, and machine sounds, while adjusting playback (e.g., pause content) when detecting certain sound classes 130 (e.g., sirens/alerts). In certain cases, the response 300 is formatted such that when a particular sound class 130 (e.g., sirens or alerts sounds) is detected, the processor 50 is configured to pause audio content (e.g., pause streaming or playback) and enable full transparency (or hear-through) of that class 130, e.g., sirens or alert sounds. The response 300 is formatted to adjust (e.g., reduce) ANR (or, active noise cancelling) on select additional sound classes 130, e.g., transportation sounds, speech, and machine sounds.

In further aspects, the user input 220 can be used to control functions 270 of a service 280 utilized by the audio device 20. For example, a service 280 can include a network and/or cloud-based music or audio content service such as an internet radio service. In certain cases, the user input 220 can be used to control functions 270 of the service 280, which in some cases, enables control of at least one of, a song or a track, an artist, a playlist, or a content channel.

In various implementations, as described herein the ML model 30 need not have been pre-trained with the user input 220 to determine the control action 230 for the at least one attribute 250 of the audio device 20, or to determine the service function 270 for the service 280. In various examples, determining the control action 230 includes selecting at least one attribute 250 of the audio device 20 based on inferred intent from the user input 220. That is, in various implementations the ML model 30 (in particular, control action determination model 240) includes at least one inference layer that is configured to infer the intent from a user command, e.g., an input 220. In certain cases, the inference layer(s) apply a nested selection approach to infer intent from the input 220.

In some aspects, the nested selection approach includes applying a local portion of the ML model run on the at least one audio capture device 40 or the audio device 20, e.g., ML model 30′, shown as local to processor(s) 50 in FIG. 2. The local portion 30′ of the ML model can be used to determine the control action in various implementations. If the attribute(s) of the audio device 20 are not selected by applying the local portion of the ML model 30′, the approach can further include applying an off-device portion of the ML model 30 to determine the control action, e.g., as described with respect to process P102. In certain of these cases the off-device portion of the ML model 30 is run on a smart device other than the audio capture device 20, 40 and/or a cloud-based or network-based system. In some examples, the nested selection approach includes evaluating the inferred intent relative to control functions of the audio device 20 prior to control functions of a service (e.g., service 280) utilized by the audio device 20.

In some examples, the control functions of the audio device 20 include on-device functions or grouping functions. In particular aspects, control functions of the audio device enable control of at least one of, transport control, volume, active noise reduction (ANR), audio device grouping, equalization, spatial audio controls (e.g., motion versus still), transparency mode, or channel playback (e.g., stereo, left/right, coordinating channels with another speaker, and/or party mode). In certain aspects, the service 280 includes an audio streaming service or an internet radio service. In further aspects, control functions of the service 280 utilized by the audio device 20 enable control of at least one of, a song or a track, an artist, a playlist, or a content channel. In this approach, local functions controlled at the audio device 20 can be evaluated prior to functions controlled by a remote service such as service 280, which can provide certain benefits, e.g., reduced latency, reduced power/battery usage, and/or greater efficiency in executing commands.

In some cases, the ML model 30 is configured to update the local ML model 30′ based on inputs 220 and corresponding responses 300 from the ML model 30, to codify the inferred intent of the user inputs 200 in the ML model 30′ running locally at the audio device 20. In these cases, the ML model 30′ can be updated (e.g., on a per-input basis, periodically, or in response to a trigger such as Wi-Fi connection, power cycling, etc.) based on learned input-response pairings from the ML model 300. The updated ML model 30′ can progressively improve intent inference based on input-response pairings. Further, because the ML model 30 can interface with a plurality of audio devices 20 (e.g., from a group of users), the ML model 30 can efficiently inform updates to intent inference at the ML model 30′.

In particular cases, the ML model 30′ run at the audio capture device 20, 40 and/or other device with processor 50 can be referred to as “light,” function-limited, or including a function-limited operational mode. In certain cases, the processor 50 is configured, in response to detecting a threshold latency in network communication, to run the ML model 30′ in the function-limited operational mode on the device(s) 20, 40 to improve the efficiency in the response to the user input 220. For example, the processor 50 can be configured to monitor network communication latency, and in response to the detected latency satisfying a latency threshold, run the function-limited ML model 30′ locally to determine the intended control action for the audio device 20.

Returning to FIG. 5, after the control action is determined and response 300 is provided, the processor 50 is configured to cause the determined control action 230 to be performed (process P103). As noted herein, control actions 230 can include a change in the attribute 250 and/or maintaining of the attribute 250 identified from the input 220. In particular cases, the method further includes an optional process (P102A) including providing an audible response to the user input 220, e.g., a voice assistant response at the transducer(s) at the audio device 20 and/or device 40 (or another connected audio device 20 in space 5). For example, as noted herein, the audible response can include a natural language response including a query for an additional user input. In certain examples, the query includes a natural language based conversational response, such as from a virtual personal assistant, chatbot, or large language model. For example, the processor 50 can be configured to provide a response to the user input, e.g., via an audible response and/or text response to aid the user in understanding the nature of the adjustment and/or to facilitate a dialog to iterate adjustment. In one example, the processor 50 outputs an audible or text response such as, “OK, I've turned down everything but the important sounds you requested. Is there anything else I can help with? ”

### Example: Training/Running ML Model

Various implementations describe running the ML model 30 (e.g., LLM) to enhance audio device operation and/or source selection. Further implementations can include a method of interfacing with (training and/or running) the ML model 30, including for example:
(I) training the LLM by: capturing microphone signals including ambient sounds from microphones 80 at audio device 20; detecting classes of sound sources in the ambient sounds; and providing the microphone signals and sound source classifications to the LLM to aid in future classification of ambient sounds; and
(II) running the LLM by: sending natural language (NL) prompts to the LLM associated with detected user inputs; and receiving audio device settings values from the LLM based on the user inputs.

In some cases, training includes providing natural language (NL) prompts to the LLM associated with the sound source classifications, and/or providing contextual usage cues for the audio device 20 with the sound source classifications and microphone signals. In further cases, the user inputs detected when running the LLM include contextual cues inferring user intent based on operation of the audio device 20. In additional cases, the user inputs detected when running the LLM include at least one user selection.

As noted herein, in contrast to conventional approaches, various implementations include audio devices, approaches and systems for selectively adjusting classes of sound sources in ambient sound. Particular implementations are configured to identify classes of ambient sound sources and differentiate audio output between at least two distinct ambient sound sources, e.g., enhancing a given ambient sound source relative to another ambient sound source, canceling a given ambient sound source relative to another ambient sound source, etc.

Additional implementations include controlling audio devices using natural language based commands and a machine learning (ML) model. In particular cases, user input (which may included inferred intent) detected at an audio capture device is routed through an ML model to determine a control action for at least one attribute of the audio device, and based on processing by the ML model, the control action is performed. As noted herein, various implementations include providing response formatting information to the ML model to elicit a response that addresses the user input. Response formatting performed by the processor can obviate the need for a model that is trained with user inputs, and/or enhance the efficiency and/or accuracy of the decision-making process by the ML model. In any case, the approaches described according to various implementations have the technical effect of enhancing the efficiency and/or accuracy of control action selection for an audio device or a group of audio devices. Further, the disclosed implementations can enhance the user experience by enabling customized (or mode-based) enhancement/cancelation of noise sources.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations.

In some implementations, the host-based elements of the approach are implemented in a software module (e.g., an “App”) that is downloaded and installed on the source/host (e.g., a “smartphone”), in order to provide the controlled audio output aspects according to the approaches described above. In particular cases, functions such as input routing control can be controlled by a centralized interface command, e.g., a command at an interface on one of the audio devices.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

A number of implementations have been described. Nevertheless, it will be understood that additional modifications may be made without departing from the scope of the inventive concepts described herein, and, accordingly, other embodiments are within the scope of the following claims.

We claim:

1. An audio device comprising:
an electro-acoustic transducer for providing an audio output;
a set of microphones for detecting ambient sounds; and
a processor coupled with the electro-acoustic transducer and the set of microphones, the processor configured to:
evaluate microphone signals from the set of microphones to identify classes of sound sources in the ambient sounds; and
adjust output of at least one class of the ambient sounds relative to another class of ambient sounds based on a user input.

2. The audio device of claim 1, wherein the processor is configured to identify at least one of the following classes of sound sources: i) nearby voice, ii) alerts and sirens, iii) nearby transit, iv) out loud music, v) background sounds, vi) nature and animals.

3. The audio device of claim 1, wherein the processor is configured to operate in a plurality of modes including two or more of: a) quiet mode, b) aware mode, c) safety mode, d) atmosphere mode, e) voice boost mode, or f) custom mode,
wherein the processor is configured to automatically select one of the plurality of modes based on at least one of a contextual indicator or a usage indictor.

4. The audio device of claim 3, wherein adjusting the output includes separating at least two of the identified classes of sound source.

5. The audio device of claim 1, wherein the processor is configured to provide at least three interface options for sound source selection.

6. The audio device of claim 5, wherein the interface options include a full manual control, whereby the user adjusts a plurality of classes of ambient sounds on a per-class basis.

7. The audio device of claim 5, wherein the interface options include a modes-based control, whereby predefined mixes of class-based settings are provided to the user for selection.

8. The audio device of claim 5, wherein the interface options include a natural language (NL) based control mode, whereby the at least one class of sound sources is selected by a user natural language command.

9. The audio device of claim 8, wherein in the NL based control mode, the processor is configured to:
convert the user natural language command into a natural language input; and
provide the natural language input to a machine learning (ML) model for identifying the at least one class of sound sources based on the natural language input.

10. The audio device of claim 9, wherein the processor is further configured to provide at least one of the following to the ML model: audio device context data about usage of the audio device, or a set of controllable attributes for the audio device.

11. The audio device of claim 10, wherein the set of controllable attributes are defined in terms of an application programming interface (API).

12. The audio device of claim 9, wherein the ML model includes a large language model (LLM).

13. The audio device of claim 1, wherein the processor is configured to differentiate between user selection of ambient acoustic signals that include music from music playback at the audio device.

14. The audio device of claim 1, wherein the user input is provided via a voice command.

15. The audio device of claim 1, wherein the user input is provided via a user profile command.

16. The audio device of claim 1, wherein the user input is a default user input at startup of the audio device.

17. An audio device comprising:
an electro-acoustic transducer for providing an audio output;
a set of microphones for detecting ambient sounds; and
a processor coupled with the electro-acoustic transducer and the set of microphones, the processor configured to:
receive a user command to adjust a control function at the audio device;
convert the user command into a natural language input;
provide the natural language input to a machine learning (ML) model for identifying the control function based on the natural language input;
receive a formatted response indicating the control function from the ML model; and
execute the control function at the audio device based on the formatted response.

18. The audio device of claim 17, wherein the processor is further configured to provide at least one of the following to the ML model: audio device context data about usage of the audio device, or a set of controllable attributes for the audio device.

19. The audio device of claim 17, wherein the set of controllable attributes are defined in terms of an application programming interface (API).

20. The audio device of claim 17, wherein the ML model includes a large language model (LLM).

21. The audio device of claim 17, wherein the control function is selected from: audio class selection from ambient noise, playback control functions, transport control functions, active noise reduction (ANR) control functions, connectivity control functions, playback source control functions, or audio setting control functions.

22. The audio device of claim 17, wherein the ML model is run at a device separate from the audio device.

23. The audio device of claim 17, wherein a version of the ML model is run locally at the audio device, wherein the version of the ML model run locally at the audio device is a lightweight version of the ML model.

24. The audio device of claim 17, wherein the user command includes a sound source class selection, and wherein the processor is further configured to:
evaluate microphone signals from the set of microphones to identify classes of sound sources in the ambient sounds; and
adjust output of at least one class of the ambient sounds relative to another class of ambient sounds based on the sound source class selection.

25. A method of interfacing with a large language model (LLM) for sound source classification, the method comprising:
training the LLM by:
capturing microphone signals including ambient sounds from a set of microphones at an audio device;
detecting classes of sound sources in the ambient sounds; and
providing the microphone signals and sound source classifications to the LLM to aid in future classification of ambient sounds.

26. The method of claim 25, further comprising providing natural language (NL) prompts to the LLM associated with the sound source classifications.

27. The method of claim 25, further comprising providing contextual usage cues for the audio device with the sound source classifications and microphone signals.

28. The method of claim 25, further comprising running the LLM by:
sending natural language (NL) prompts to the LLM associated with detected user inputs; and
receiving audio device settings values from the LLM based on the user inputs.

29. The method of claim 28, wherein the user inputs include at least one of: i) contextual cues inferring user intent based on operation of the audio device, or ii) a user selection.
